(19) United States
(12) Patent Application Publication
(10) Pub. No.: US 2024/0149814 A1
(43) Pub. Date: May 9, 2024

(54) VEHICLE

(71) Applicant: TOYOTA JIDOSHA KABUSHIKI KAISHA, Aichi-ken (JP)

(72) Inventor: Takahisa MIURA, Nagoya-shi (JP)

(21) Appl. No.: 18/467,726

(22) Filed: Sep. 15, 2023

(30) Foreign Application Priority Data
Nov. 8, 2022 (JP) 2022-178718

(51) Int. Cl. B60R 16/033

(52) U.S. Cl. CPC B60R 16/033

(57) ABSTRACT

A vehicle includes an electric motor, a battery that is charged by electric power generated by the electric motor, a power control unit configured to control the electric power generated by the electric motor, and a connection control unit configured to control connection between the battery and the electric motor, wherein when the power control unit cannot control the electric power generated by the electric motor, the electric motor autonomously generates electric power, and when the electric motor autonomously generates electric power and a temperature of the battery is lower than a predetermined temperature, the connection control unit disconnects the connection between the battery and the electric motor.

### CROSS-REFERENCE TO RELATED APPLICATION

This application is based upon and claims the benefit of priority of the prior Japanese Patent Application No. 2022-178718, filed on Nov. 8, 2022, the entire contents of which are incorporated herein by reference.

### FIELD

The present disclosure relates to a vehicle.

### BACKGROUND

A vehicle equipped with an internal combustion engine, an electric motor, and a battery is known as disclosed in, for example, Japanese Patent Application Laid-Open No. 2009-298301. The battery is charged by electric power generated by the electric motor.

### SUMMARY

Batteries deteriorate due to overcharge, overdischarge, and the like. Therefore, an object of the present disclosure is to provide a vehicle capable of protecting a battery.

In one aspect of the present disclosure, there is provided a vehicle including: an electric motor; a battery that is charged by electric power generated by the electric motor; a power control unit configured to control the electric power generated by the electric motor; and a connection control unit configured to control connection between the battery and the electric motor, wherein when the power control unit cannot control the electric power generated by the electric motor, the electric motor autonomously generates electric power, and wherein when the electric motor autonomously generates electric power and a temperature of the battery is lower than a predetermined temperature, the connection control unit disconnects the connection between the battery and the electric motor.

The connection control unit may change the predetermined temperature in accordance with deterioration of the battery.

When the electric motor autonomously generates electric power, a temperature of the battery is equal to or higher than a predetermined temperature, and electric power input to the battery and electric power output from the battery exceed a predetermined range, the connection control unit may disconnect the connection between the battery and the electric motor.

In another aspect of the present disclosure, there is provided a vehicle including: an electric motor; a battery that is charged by electric power generated by the electric motor; an accessory configured to be driven by the electric power generated by the electric motor; a first power control unit configured to control the electric power generated by the electric motor; and a second power control unit configured to control electric power consumed by the accessory, wherein when the first power control unit cannot control the electric power generated by the electric motor, the electric motor autonomously generates electric power, and wherein when the electric motor autonomously generates electric power and the electric power generated by the electric motor is larger than the electric power consumed by the accessory by a predetermined electric power or more, the second power control unit increases the electric power consumed by the accessory.

### BRIEF DESCRIPTION OF THE DRAWINGS

FIG. 1 illustrates a vehicle in accordance with a first embodiment;

FIG. 2 is a flowchart illustrating a process in the first embodiment;

FIG. 3 illustrates threshold values; and

FIG. 4 is a flowchart illustrating a process in a second embodiment.

### DETAILED DESCRIPTION

### First Embodiment

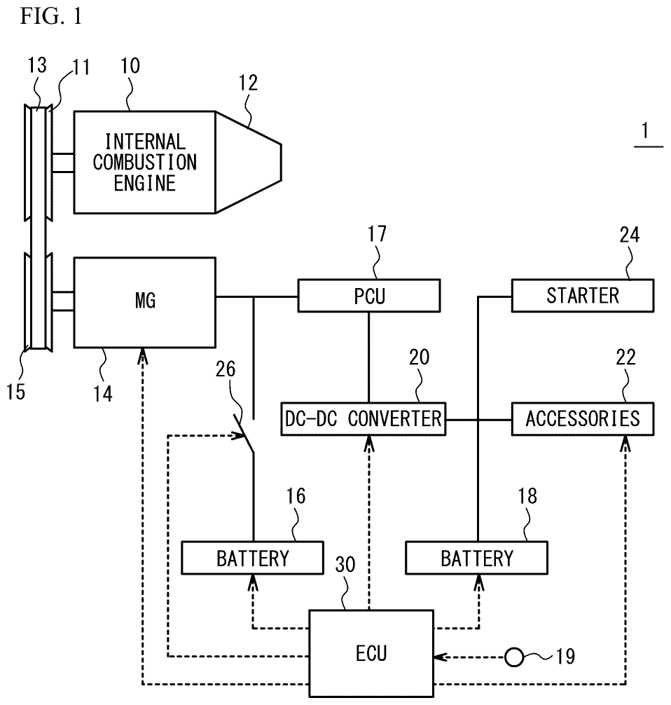

Hereinafter, a vehicle of the present embodiment will be described with reference to the drawings. FIG. 1 illustrates a vehicle 1 in accordance with a first embodiment. The vehicle 1 includes an internal combustion engine 10, a transmission 12, a motor generator (MG) 14 (electric motor), batteries 16 and 18, a direct current (DC)-DC converter 20, accessories 22, a starter 24, a switch 26, and an electronic control unit (ECU) 30.

The internal combustion engine 10 may be a gasoline engine or a diesel engine. The internal combustion engine 10 generates power by burning fuel such as gasoline. The power is transmitted to drive wheels (not illustrated) through the transmission 12. The vehicle 1 travels using power generated by the internal combustion engine 10. Also when an abnormality occurs in the vehicle 1, the evacuation traveling is performed by the power of the internal combustion engine 10.

The MG 14 functions as a motor and a power generator. The MG 14 outputs torque when drive power is supplied thereto, and generates regenerative power when torque is applied thereto. The MG 14 is, for example, an AC rotating electric machine. The AC rotating electric machine is, for example, a permanent magnet type synchronous motor including a rotor in which permanent magnets are embedded. The MG 14 includes a microcomputer (not illustrated).

A pulley 11 is attached to the crankshaft of the internal combustion engine 10. A pulley 15 is attached to the rotor of the MG 14. A belt 13 is wound around the pulley 11 and the pulley 15. When the internal combustion engine 10 rotates, power is transmitted to the MG 14 through the pulley 11, the belt 13, and the pulley 15. The MG 14 rotates and generates electrical power.

The battery 16 and the battery 18 are secondary batteries, and can be discharged and charged. The battery 18 is, for example, a 12 V battery. The battery 16 is, for example, a nickel metal hydride battery or a lithium ion battery, and is a battery having a higher voltage than the battery 18. A temperature sensor 19 measures the temperature of the battery 16.

The MG 14 is electrically connected to the battery 16 and the DC-DC converter 20 through a power control unit (PCU) 17. The switch 26 is provided between the MG 14 and the battery 16. The switch 26 is, for example, a relay.

The PCU 17 includes an inverter. The PCU 17 converts AC power generated by the MG 14 into DC power. The battery 16 is charged by the electric power generated by the MG 14.

The DC-DC converter 20 steps down the electric power generated by the MG 14 and supplies the stepped-down electric power to the battery 18, the accessories 22, and the starter 24. The starter 24 starts the internal combustion engine 10. The battery 18 is charged by electric power supplied from the MG 14. The accessories 22 include lights, an air conditioner, and the like. The accessories 22 are driven by the electric power supplied from the MG 14.

The ECU 30 is a control device of the vehicle 1 and includes an arithmetic device such as a central processing unit (CPU) and a storage device such as a random access memory (RAM) and a read only memory (ROM). The ECU 30 performs various types of control by executing programs stored in the ROM or the storage device.

The ECU 30 functions as a power control unit that controls the electric power generated by the MG 14, and as a connection control unit that controls electrical connection between the MG 14 and the battery 16. The ECU 30 controls the connection by turning on and off the switch 26. The ECU 30 acquires the temperature of the battery 16 measured by the temperature sensor 19.

When communication between the ECU 30 and the MG 14 is secured, the ECU 30 can control the electric power generated by the MG 14. When the communication between the ECU 30 and the MG 14 is disrupted, the ECU 30 cannot control the electric power generated by the MG 14. The MG 14 autonomously generates electric power. During execution of autonomous power generation, the electric power generated by the MG 14 is controlled by a microcomputer (not illustrated).

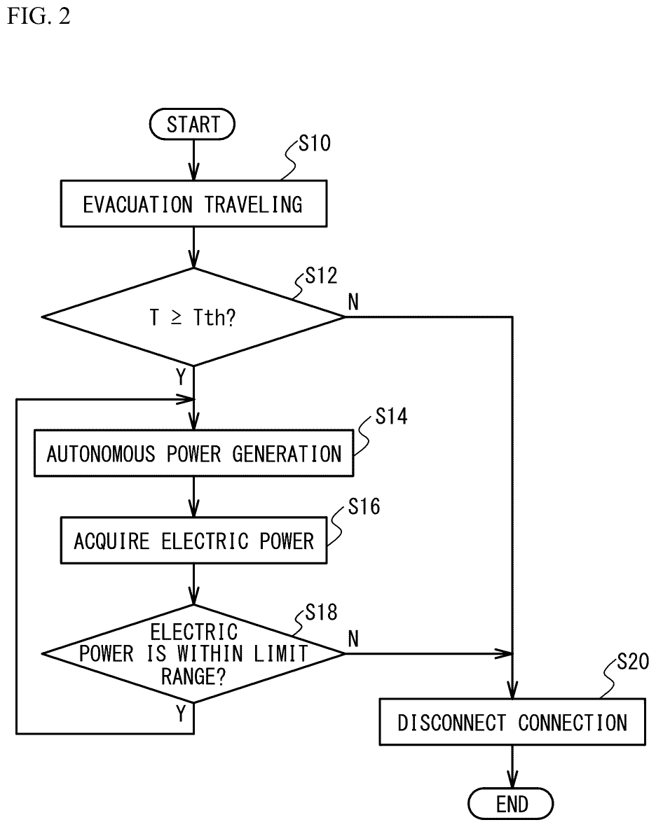

FIG. 2 is a flowchart illustrating a process in the first embodiment. It is assumed that communication between the ECU 30 and the MG 14 is disrupted. As illustrated in FIG. 2, the vehicle 1 performs evacuation traveling (step S10). The ECU acquires the temperature T of the battery 16 and determines whether the temperature T is equal to or higher than a predetermined temperature Tth (step S12). When the determination is affirmative (Yes), the MG 14 executes autonomous power generation (step S14). The ECU 30 acquires the electric power input to and output from the battery 16 (step S16), and determines whether the input electric power and the output electric power are within the limit range (step S18). When the determination is affirmative, the process returns to step S14. The MG 14 continues autonomous power generation. When a negative determination (No) is made in step S18, the ECU 30 turns off the switch 26 to disconnect the electrical connection between the MG 14 and the battery 16 (step S20).

When the temperature T of the battery 16 is lower than the predetermined temperature Tth, a negative determination is made in step S12. The ECU 30 turns off the switch 26 to disconnect the electrical connection between the MG 14 and the battery 16 (step S20). The electric power generated by the MG 14 is not input to the battery 16. After step S20, the process ends.

The battery 16 is deteriorated by overcharging and overdischarging, for example. The ECU 30 controls the electric power generated by the MG 14 to prevent the battery 16 from deteriorating. When communication with the MG 14 is lost, the MG 14 performs autonomous power generation. The ECU 30 cannot control the electric power generated by the MG 14. The ECU 30 monitors the electric power and turns off the switch 26 when there is a risk of deterioration of the battery 16 (steps S14, S16, S18 and S20 in FIG. 2, fail safe). By interrupting the input and output of the electric power, deterioration is inhibited. However, when the temperature is low, the battery 16 is particularly susceptible to degradation. While the electric power is monitored, the battery 16 may degrade.

In the first embodiment, when the MG 14 is performing autonomous power generation and the temperature T is lower than the predetermined temperature Tth, the ECU 30 turns off the switch 26 to disconnect the electrical connection between the MG 14 and the battery 16. Electric power generated by the MG 14 is not input to the battery 16. Deterioration of the battery 16 can be inhibited.

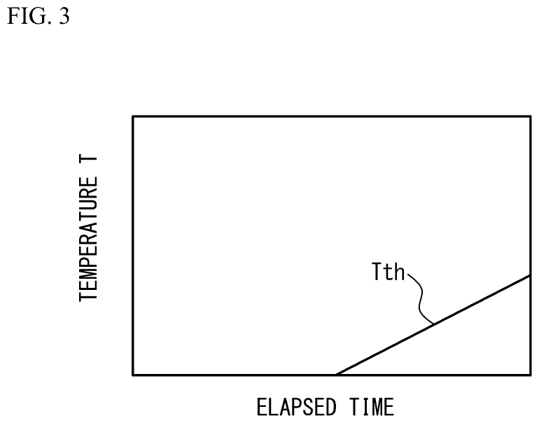

The ECU 30 changes the threshold value Tth for the temperature as the battery 16 deteriorates. The deterioration of the battery 16 is determined from, for example, the elapsed time from the time of manufacture of the battery 16. FIG. 3 illustrates the threshold value Tth. The horizontal axis represents the elapsed time from the time of manufacture of the battery 16. The vertical axis represents temperature. The solid line in the figure represents the threshold value Tth. When the temperature is below the solid line, the ECU 30 turns off the switch 26. The battery 16 is not charged. When the temperature is above the solid line, the ECU 30 does not turn off the switch 26. The MG 14 performs autonomous power generation.

As illustrated in FIG. 3, the threshold value Tth changes. When the elapsed time of the battery 16 is short, the battery 16 is less likely to deteriorate. Therefore, the threshold value Tth is not set. The MG 14 performs autonomous power generation regardless of the temperature. As the elapsed time increases, the battery 16 deteriorates more. The threshold value Tth is increased. Since the range in which the battery 16 is not charged is widened, deterioration of the battery 16 is inhibited. That is, when the battery 16 is less likely to deteriorate, the MG 14 performs autonomous power generation. When the battery 16 is deteriorated, electric power from the MG 14 is not input to the battery 16. This inhibits further deterioration.

When the MG 14 performs autonomous power generation and the temperature T is equal to or higher than the threshold value Tth, the ECU 30 monitors electric power. When the electric power is within a predetermined range (limit range), the MG 14 performs autonomous power generation and the battery 16 is charged. When the electric power exceeds the limit range, the ECU 30 turns off the switch 26 (step S20). The fail-safe function suppresses deterioration of the battery 16.

### Second Embodiment

Description of the same configuration as that of the first embodiment will be omitted. The configuration illustrated in FIG. 1 is common to the second embodiment. The ECU 30 functions as a first power control unit that controls electric power generated by the MG 14. The ECU 30 functions as a second power control unit that controls the electric power consumed by the accessories 22.

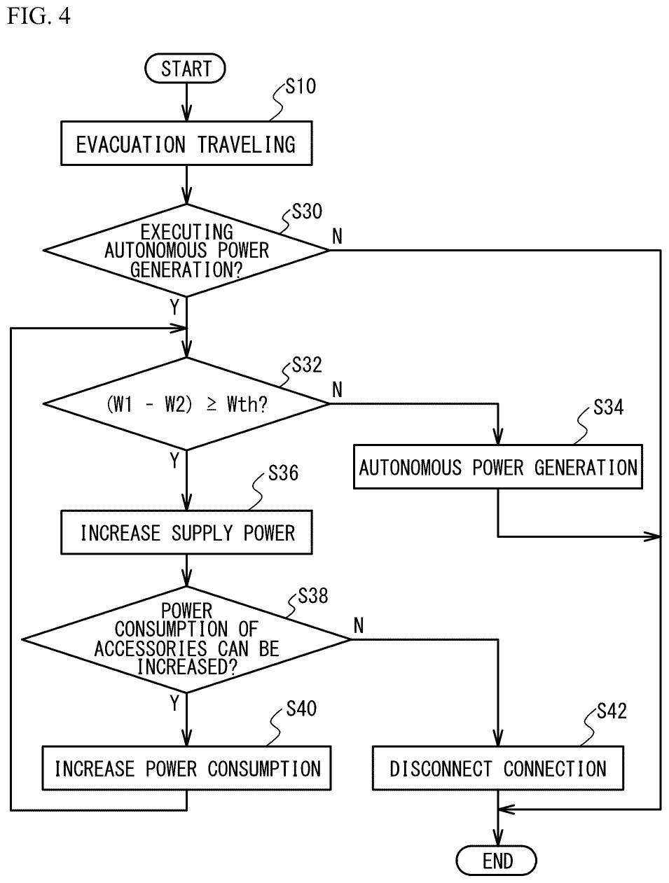

FIG. 4 is a flowchart illustrating a process in the second embodiment. The vehicle 1 is performing evacuation traveling (step S10). The ECU 30 determines whether the MG 14 is executing autonomous power generation (step S30). When communication with the MG 14 is possible, a negative determination is made in step S30. In this case, the process of FIG. 4 ends. The ECU 30 controls the electric power of the MG 14.

When communication with the MG 14 is not possible, an affirmative determination is made in step S30. The ECU 30 determines whether the difference between the electric power W1 generated by the MG 14 and the electric power W2 consumed by the accessories 22 is equal to or greater than a predetermined electric power Wth (step S32). When a negative determination is made, the ECU 30 does not turn off the switch 26 and maintains the connection between the MG 14 and the battery 16. The MG 14 performs autonomous power generation (step S34).

When an affirmative determination is made in step S32, the ECU 30 increases the electric power supplied from the DC-DC converter 20 to the battery 18 and the accessories 22 (step S36). The ECU 30 determines whether the power consumption of the accessories 22 can be increased (step S38). When an affirmative determination is made, the ECU 30 increases power consumption (step S40). For example, the ECU 30 operates a device that has not been operated among the accessories 22. The ECU 30 may increase the brightness of the lights among the accessories 22 or may change the set temperature of the air conditioner. The process returns to step S32.

When a negative determination is made in step S38, the ECU 30 turns off the switch 26 to disconnect the connection between the MG 14 and the battery 16 (step S42). After step S30, step S34, or step S42, the process ends.

In the second embodiment, when the MG 14 is executing autonomous power generation and the generated power W1 of the MG 14 is larger than the power consumption W2 of the accessories 22 by the electric power Wth or greater, the ECU increases the power consumption of the accessories 22 (step S40). Electric power generated by the MG 14 is consumed by the accessories 22. Of the electric power generated by the MG 14, the electric power consumed by the accessories 22 is increased, and the increase in the electric power used to charge the battery 16 is reduced. Therefore, deterioration of the battery 16 is inhibited. When it is difficult to increase the power consumption of the accessories 22, the ECU 30 turns off the switch 26 to disconnect the connection between the MG 14 and the battery 16 (step S42). Since the supply of electric power to the battery 16 is stopped, deterioration of the battery 16 is inhibited.

The first embodiment and the second embodiment may be independent of each other or may be combined with each other. The ECU 30 switches ON and OFF of the switch 26 according to the temperature. The ECU 30 increases the power consumption of the accessories 22 according to the generated power W1 and the power consumption W2. The battery 16 can be protected. The vehicle 1 may be a hybrid vehicle or an electric vehicle.

Although some embodiments of the present invention have been described in detail, the present invention is not limited to the specific embodiments but may be varied or changed within the scope of the present invention as claimed.

What is claimed is:

1. A vehicle comprising:
an electric motor;
a battery that is charged by electric power generated by the electric motor;
a power control unit configured to control the electric power generated by the electric motor; and
a connection control unit configured to control connection between the battery and the electric motor,
wherein when the power control unit cannot control the electric power generated by the electric motor, the electric motor autonomously generates electric power, and
wherein when the electric motor autonomously generates electric power and a temperature of the battery is lower than a predetermined temperature, the connection control unit disconnects the connection between the battery and the electric motor.

2. The vehicle according to claim 1, wherein the connection control unit changes the predetermined temperature in accordance with deterioration of the battery.

3. The vehicle according to claim 1, wherein when the electric motor autonomously generates electric power, a temperature of the battery is equal to or higher than a predetermined temperature, and electric power input to the battery and electric power output from the battery exceed a predetermined range, the connection control unit disconnects the connection between the battery and the electric motor.

4. A vehicle comprising:
an electric motor;
a battery that is charged by electric power generated by the electric motor;
an accessory configured to be driven by the electric power generated by the electric motor;
a first power control unit configured to control the electric power generated by the electric motor; and
a second power control unit configured to control electric power consumed by the accessory,
wherein when the first power control unit cannot control the electric power generated by the electric motor, the electric motor autonomously generates electric power, and
wherein when the electric motor autonomously generates electric power and the electric power generated by the electric motor is larger than the electric power consumed by the accessory by a predetermined electric power or more, the second power control unit increases the electric power consumed by the accessory.
